(19) United States
(12) Patent Application Publication
(10) Pub. No.: US 2026/0028492 A1
(43) Pub. Date: Jan. 29, 2026

(54) MAGNETOELECTRIC COMPOSITES AND PRINTABLE INKS AND METHODS FOR MAKING AND USING THEM

(71) Applicant: SAN DIEGO STATE UNIVERSITY (SDSU) FOUNDATION, DBA SAN DIEGO STATE UNIVERSITY RESEARCH FOUNDATION, San Diego, CA (US)

(72) Inventors: George YOUSSEF, San Diego, CA (US); Amritesh KUMAR, San Diego, CA (US); Nitai Chandra ADAK, San Diego, CA (US)

(21) Appl. No.: 19/282,698

(22) Filed: Jul. 28, 2025

Related U.S. Application Data
(60) Provisional application No. 63/675,896, filed on Jul. 26, 2024.

(51) Int. Cl. C09D 11/108; B29C 64/106; B33Y 10/00; B33Y 70/10; B33Y 80/00; C09D 11/033

(52) U.S. Cl. CPC C09D 11/108; B29C 64/106; C09D 11/033; B33Y 10/00; B33Y 70/10; B33Y 80/00

(57) ABSTRACT

In alternative embodiments, compositions, including products of manufacture and kits, are provided that comprise magnetoelectric composites comprising ferromagnetic and ferroelectric constituents, as well as methods for making and using them. In alternative embodiments, printable inks or organic-based magneto-strictive magnetoelectric materials comprise: poly(vinylidene fluoride) and/or polyvinylidene fluoride (also called polyvinylidene difluoride, or PVDF) dissolved in a nonpolar organic solvent, where a piezoelectric polymer is dissolvable (optionally dimethyl sulfoxide (DMSO), or equivalent).

### CROSS-REFERENCE TO RELATED APPLICATIONS

This application claims priority to U.S. Provisional Patent Application Ser. No. 63/675,896, filed Jul. 26, 2024, which is incorporated by reference herein in its entirety for all purposes.

### STATEMENT OF FEDERALLY SPONSORED RESEARCH

This invention was made with government support under N00174-23-1-0009, W911NF2310150, and W911NF2310329, awarded by the Department of Defense (DOD). The government has certain rights in the invention.

### FIELD

This invention generally relates to magnetoelectric composites and additive manufacturing (also known as 3D printing).

### BACKGROUND

Magnetoelectric composites are a material system with coupled electrical, mechanical, and magnetic properties as a function of temperature and/or other applied boundary conditions. In particular, magnetoelectric composite materials comprise ferromagnetic and ferroelectric constituents, creating intrinsic or extrinsic coupling between their magnetic and electric properties via mechanical strain, so that one property (magnetic or electric) can be manipulated by applying the other field. The magnetoelectric effect implies that applying an external magnetic field induces electric polarization, while applying an electric field (i.e., voltage across the thickness) results in changes in magnetization. However, while magnetoelectric composites can provide many useful benefits and applications, exploring and designing magnetoelectric composites to achieve specific characteristics, such as enhanced sensitivity, improved performance, novel functionalities, etc., can be difficult.

Magnetoelectric composite materials can be engineered at the nanoscale to optimize their properties for different applications. On the other hand, additive manufacturing, also known as 3D printing, has attracted continuous research, readily enabling the fabrication of complex materials and geometries. Improvements to additive manufacturing hinge on novel materials with single or multiple functionalities, for example, magnetoelectric composites. However, printing such complex materials has yet to be attainable, given the ultra-sensitivity of the constituents to operating and manufacturing conditions, such as the oxidation of magnetic nanoparticles during mixing.

The current state-of-the-art in magnetoelectric composites is limited due to one or more of the following drawbacks: complex time-temperature and stress dependent behavior of piezoelectric polymers; difficulty with maintaining the multifunctional properties of the magnetostrictive magnetoelectric composites after a 3D printing process; selection of non-biocompatible solvents restricting the freedom of versatile applicability like biomedical applications; difficulty in maintaining the flowability of the composite inks as magnetic nanoparticles create agglomeration or clogging in the outlet of nozzle tip; restriction of layer-by-layer deposition due to non-availability of curing systems at that instant; and/or difficulty in printing different composite inks, e.g., by using a single G-code and M-code for 3D printers.

### SUMMARY

Example embodiments of the invention provide, among other things, compositions comprising magnetoelectric composites comprising ferromagnetic and ferroelectric constituents, and methods for making and using them. Products of manufacture and kits, including such magnetoelectric composites, are also provided.

In alternative embodiments, provided are printable inks or, more generally, organic-based magneto-strictive magnetoelectric materials, comprising: poly(vinylidene fluoride) and/or polyvinylidene fluoride (also called polyvinylidene difluoride, or PVDF) dissolved in a nonpolar organic solvent where a piezoelectric polymer is dissolvable.

In alternative embodiments, of printable inks or organic-based magneto-strictive magnetoelectric materials as provided herein:
the printable ink or organic-based magneto-strictive magnetoelectric material may be contained on and/or within a plurality of nickel (Ni) and/or ferric oxide (Fe₃O₄) nanoparticles and/or microparticles,
the printable ink or the organic based magneto-strictive magnetoelectric material may have between about 0.25 weight (wt.) % to 10 wt. %, or 0.5 wt. %, 1 wt. %, 2 wt. %, 3 wt. %, 4 wt. %, 5 wt. %, 6 wt. % or 7 wt. %, of plurality of nickel (Ni) and and/or ferric oxide (Fe₃O₄) nanoparticles and/or microparticles;
the nonpolar organic solvent may comprise dimethyl sulfoxide (DMSO), or a dimethyl sulfoxide equivalent;
the dimethyl sulfoxide or equivalent may comprise: a zwitterion-type ionic liquid (ZIL) (optionally 1-[2-(2-methoxyethoxy)ethyl]-3-(3-carboxypropyl)-imidazolium (OE2imC3C) and 1-[2-(2-methoxyethoxy)ethyl]-3-(3-carboxypentyl)-imidazolium (OE2imC5C)); dihydrolevoglucosenone (or CYRENE™); or, mixtures of: DMSO/ethyl acetate (EtOAc), DMSO/1,3-dioxolane (DOL) or DMSO/2-methyl tetrahydrofuran (2-Me-THF));
the printable inks or organic-based magneto-strictive magnetoelectric materials may further comprise: an ultraviolet photo-initiator;
the photo-initiator may be tuned at 405 nm;
the photo-initiator may comprise: VA-086, CAS no. 61551-69-7 (also known as 2,2′-Azobis [2-methyl-N-(2-hydroxyethyl) propionamide]); LUCIRIN™ (BASF), camphorquinone (CQ); Hydroxyacetophenone (HAP), and/or Phosphineoxide (TPO);
the printable inks or organic-based magneto-strictive magnetoelectric materials may further comprise: a plurality of magnetic nanoparticles or microparticles;
the plurality of magnetic nanoparticles or microparticles may comprise or be fabricated with: an iron oxide (optionally iron oxide magnetite); terfenol-D, or an alloy of the formula TbₓDy₁₋ₓFe₂, wherein x is about 0.3; terbium, dysprosium and iron alloy; nickel or a nickel-iron alloy (such as INVAR™); galfenol (an alloy of iron and gallium), or, any material capable of changing magnetization in the presence of magnetic field.

In alternative embodiments, provided are products of manufacture comprising or incorporating therein printable ink, or an organic-based magneto-strictive magnetoelectric material as provided herein.

In alternative embodiments, the product of manufacture may be fabricated as one or more of or using: a 3D printer.

In alternative embodiments, the 3D printer may comprise or be equipped with an in situ flash heating element to assist in evaporating a DMSO or equivalent solvent at a specified temperature below the solvent's flash point.

In alternative embodiments, the product of manufacture may be a wearable electronic device.

In alternative embodiments, the product of manufacture may be an acquiescent energy storage or conversion device.

In alternative embodiments, the product of manufacture may be a flexible or wearable item of equipment or device.

In alternative embodiments, the product of manufacture may be a flexible or wearable medical item or device.

In alternative embodiments, provided are methods of making a printable ink or an organic-based magneto-strictive magnetoelectric material as provided herein, comprising:
(a) mixing the poly(vinylidene fluoride) and/or polyvinylidene fluoride (also called polyvinylidene difluoride, or PVDF) in a nonpolar organic solvent where a piezoelectric polymer is dissolvable, and
(b) adding the mix of step (a) into and/or onto a plurality of nickel (Ni) and/or ferric oxide (Fe₃O₄) microparticles or nanoparticles.

In alternative embodiments of the methods as provided herein:
the mixing may comprise stirring for about 30 minutes (min.) at about 75° C., or spinning for about 5 min at about 750 rpm, then spinning for about 25 min at about 250 rpm;
the nonpolar organic solvent may comprise dimethyl sulfoxide (DMSO), or equivalent;
the dimethyl sulfoxide or equivalent may comprise: a zwitterion-type ionic liquid (ZIL) (optionally 1-[2-(2-methoxyethoxy)ethyl]-3-(3-carboxypropyl)-imidazolium (OE2imC3C) and 1-[2-(2-methoxyethoxy)ethyl]-3-(3-carboxypentyl)-imidazolium (OE2imC5C)); dihydrolevoglucosenone (or CYRENE™); or, mixtures of: DMSO/ethyl acetate (EtOAc), DMSO/1,3-dioxolane (DOL) or DMSO/2-methyl tetrahydrofuran (2-Me-THF)).

The details of one or more exemplary embodiments of the invention are set forth in the accompanying drawings and the description below. Other features, objects, and advantages of the invention will be apparent from the description and drawings, and from the claims.

All publications, patents, patent applications, American Type Culture Collection (ATCC) deposits, and National Center for Biotechnology Information (NCBI) reference sequences cited herein are hereby expressly incorporated by reference in their entireties for all purposes.

### DESCRIPTION OF THE DRAWINGS

The drawings set forth herein are illustrative of exemplary embodiments provided herein and are not meant to limit the scope of the invention as encompassed by the claims.

The present disclosure will become more fully understood from the detailed description and the accompanying drawings, wherein:

FIG. 1 depicts theoretical and experimental variations of dielectric constants of printed multifunctional films according to example embodiments as a function of nanoparticle contents in volume (vol.) %.

FIG. 2 illustrates an example printing process of a rectangular film using a modified direct ink writing 3D printer, here a V-ONE™ printer (VOLTERA™, Waterloo, Ontario, Canada). A PVDF/DMSO base or magnetoelectric inks was transferred into a 5 mL cartridge fitted with a piston dispensing mechanism to deposit a series of strategically located lines through a 230 μm nozzle at a printing speed of 80 mm·min⁻¹ and nozzle pressure of 0.72 Pa onto an approximately 50 mm×75 mm substrate (e.g., PCB boards, FR1™ (VOLTERA™) at ambient conditions using custom G-codes.

FIG. 3 illustrates a variation of thickness of the example 3D-printed films as a function of nanoparticle content (wt. %) and type (including, but not limited to, nickel magnetic nanoparticles and magnetite nanoparticles).

FIG. 4 and FIG. 5 depict rheological properties of example multifunctional printable inks as a function of shear rate (0.01-100 s⁻¹) at room temperature (the printing temperature of the ink and environment) and ink composition regarding the type and weight ratio of the magnetic nanoparticles, where FIG. 4 shows the rheological properties of magnetite nanoparticle-based magnetoelectric inks at 0.5 wt. %, 1 wt. %, 2 wt. %, and 3 wt. %, while FIG. 5 shows the properties of nickel nanoparticle-based inks at the same weight ratios.

FIGS. 6A-6D are thermogravimetric (TGA) responses (thermograms) and differential thermograms (DTG) of example synthesized magnetoelectric inks as a function of temperature (room temperature to 750° C.) and magnetic nanoparticle types and weight ratio (FIGS. 6A-4B are for magnetite nanoparticles and FIGS. 6C-6D are for nickel nanoparticles). FIGS. 6A and 6D also show the Curie temperature of magnetite and nickel nanoparticles, respectively.

FIG. 7 graphically illustrates residual weight percentages, for example, synthesized and printed inks as a function of composition, including the type and weight ratio of magnetic nanoparticles.

FIG. 8A graphically illustrates a physicochemical analysis of multifunctional printable inks using Fourier transform infrared spectroscopy (FTIR) as a function of magnetic nanoparticle type and weight ratio composition from 400 cm⁻¹ to 4000 cm⁻¹, and FIG. 8B shows the corresponding FTIR spectra in the fingerprint region, delineating the spectral peaks associated with a and B phases.

FIG. 9 graphically summarizes B-phase content ratios in neat PVDF, nickel, and magnetite nanoparticles, calculated based on the peaks corresponding to the α- and β-phases at 760 cm⁻¹ (α-phase) and 840 cm⁻¹ (β-phase).

FIGS. 10A-10B graphically illustrate a thermomechanical analysis of multifunctional printable inks as provided herein, where strain is oscillating under 20 μm amplitude from −75° C. to 150° C. at 3° C./min.

FIG. 11 includes pictorial views of example 3D printed magnetoelectric films performing various motions, including: (a) translation; (b) rotation; (c) flexing; and (d) crawling under the influence of permanent magnets.

Like reference symbols in the various drawings indicate like elements.

### DETAILED DESCRIPTION

In alternative embodiments, provided are compositions including magnetoelectric composites having ferromagnetic and ferroelectric constituents, and methods for making and using them. Also provided are products of manufacture and kits, including such compositions. Example printable inks or, more generally, organic-based magneto-strictive magnetoelectric materials, provided herein may include, for instance, poly(vinylidene fluoride) and/or polyvinylidene fluoride (also called polyvinylidene difluoride, or PVDF) dissolved in a nonpolar organic solvent where a piezoelectric polymer is dissolvable (optionally dimethyl sulfoxide (DMSO), or equivalent).

The printable ink or organic-based magneto-strictive magnetoelectric material may be contained on and/or within a plurality of magnetic nanoparticles and/or microparticles, such as but not limited to nickel (Ni) and/or ferric oxide (Fe₃O₄) nanoparticles and/or microparticles. The printable ink or organic-based magneto-strictive magnetoelectric material may additionally or alternatively include a photo-initiator, e.g., for use in curing.

In alternative embodiments, compositions and products of manufacture as provided herein provide the first 3D printable agile magnetoelectric composite ink with tunable magnetoelectric behavior and on-demand tailorable mechanical, electric, magnetic, and mechanical properties. Such inks can be employed to, for example, fabricate sensors and actuators needed for soft, self-powered robotics. In alternative embodiments, the printable ink as provided herein can be used, or can be easily modified or configured for use, for various additive manufacturing techniques, including but not limited to inkjet, liquid-dispensing, and any variation of stereolithography.

In alternative embodiments, new organic or biocompatible multifunctional printable inks are provided, new methods for the printing of synthesized ink with advanced additive manufacturing techniques, and new methods for the direct integration of the multifunctional composite films with sensing, actuation, and soft robotic applications. In alternative embodiments, organic or biocompatible multifunctional printable inks as provided herein are agile printable inks that can be used to manufacture wearable and flexible electronics.

In alternative embodiments, multifunctional magnetoelectric composite materials are provided, which can be used as the prime building materials for modern wearable electronics, acquiescent energy storage and conversion devices, flexible and wearable medical equipment, and many others. In alternative embodiments, magnetoelectric composites as provided herein can provide or be included in a material system with coupled electrical, mechanical, and magnetic properties as a function of temperature and other applied boundary conditions.

In alternative embodiments, magnetoelectric composite materials are provided, comprising ferromagnetic and ferroelectric constituents, which create intrinsic or extrinsic coupling between their magnetic and electric properties via mechanical strain, allowing for the manipulation of one property (magnetic or electric) by applying the other field. The magnetoelectric effect implies that applying an external magnetic field induces electric polarization, while applying an electric field (i.e., voltage across the thickness) results in changes in magnetization.

In alternative embodiments, magnetoelectric composites as provided herein can be engineered at the nanoscale or microscale level to optimize their properties for different applications.

In alternative embodiments, magnetoelectric composites as provided herein can be used in additive manufacturing (also known as 3D printing), and can have single or multiple functionalities, including magnetoelectric composites.

In alternative embodiments, magnetoelectric composites as provided herein can provide agile printable inks with tunable magnetoelectric behavior and on-demand tailorable mechanical, electric, magnetic, and mechanical properties.

In alternative embodiments, novel organic-based magneto-strictive magnetoelectric material frameworks are provided for multifunctional sensing and actuation. In alternative embodiments, multifunctional material frameworks as provided herein comprise: Nickel (Ni) and ferric oxide (Fe₃O₄) nanoparticles incorporating (comprising) poly(vinylidene fluoride) and/or polyvinylidene fluoride (also called polyvinylidene difluoride, or PVDF), to provide a printable composite ink. Dimethyl sulfoxide (DMSO) or equivalents (such as, for example: zwitterion-type ionic liquids (ZILs) such as 1-[2-(2-methoxyethoxy)ethyl]-3-(3-carboxypropyl)-imidazolium (OE2imC3C) and 1-[2-(2-methoxyethoxy)ethyl]-3-(3-carboxypentyl)-imidazolium (OE2imC5C); dihydrolevoglucosenone (or CYRENE™); or, mixtures of: DMSO/ethyl acetate (EtOAc), DMSO/1,3-dioxolane (DOL) or DMSO/2-methyl tetrahydrofuran (2-Me-THF)), can be provided as organic solvent to prepare the composite inks.

In alternative embodiments, provided are printable inks comprising a piezoelectric polymeric material such as poly(vinylidene fluoride), PVDF, or its derivatives of copolymers or terpolymers with electroactive behavior, suspended in a biocompatible solvent carrier such as dimethyl sulfoxide, DMSO, or any other nonpolar organic solvent where the piezoelectric polymer is dissolvable (e.g., without health hazards).

The selection of PVDF (or its derivatives) is based on its versatility and resilience. The dissolved PVDF or derivatives in organic solvent such as DMSO at a specific volume ratio constitutes a base electroactive ink (base) that can be deposited strategically, e.g., printed using, for instance, any inkjet or liquid-dispensing 3D printer. The 3D printer equipment can be equipped with an in situ flash heating element to assist in evaporating the DMSO solvent at a specified temperature below the solvent's flash point. The deposited structures (deposited by the 3D printer) can also be post-cured, e.g., using a heated vacuum oven at 100-140° C. for 2-5 hours, as a nonlimiting example.

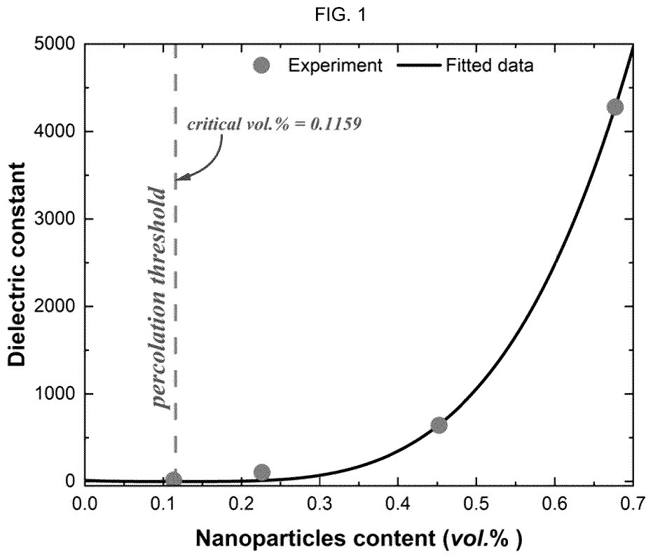

For example, FIG. 1 depicts theoretical and experimental variations of dielectric constants of printed multifunctional films according to example embodiments as a function of nanoparticle contents in volume (vol.) %. The volume fraction of the magnetic nanoparticles (MNPs) added to an example PVDF/solvent base ink is limited by avoiding conductivity; adding MNPs beyond a certain volume creates a conductive path, rendering the printed films unfit for magnetoelectric applications. This threshold is called the percolation threshold, which may be analytically calculated using the expression specified in FIG. 1, guiding the synthesis and ensuring the flowability and printability of example inks.

In alternative embodiments, a printer ink as provided herein (comprising, for example, a base such as PVDF/DMSO) may be modified with (or further comprises) an ultraviolet photo-initiator, which may optionally be tuned for a desired wavelength, 405 nm being a nonlimiting example, to facilitate the use of off-the-shelf stereolithography in any variation, allowing momentarily curing of the films during printing.

In alternative embodiments, the photo-initiator comprises: VA-086, CAS no. 61551-69-7 (also known as 2,2′-Azobis [2-methyl-N-(2-hydroxyethyl) propionamide]); LUCIRIN™ (BASF), camphorquinone (CQ); Hydroxyacetophenone (HAP), and/or Phosphineoxide (TPO). Example heat- or ultraviolet-cured films and structures printed using the base PVDF/DMSO have been shown to exhibit electroactive properties.

In alternative embodiments, a printer ink as provided herein (comprising, for example, a base such as PVDF/DMSO) further comprises (or is modified with) magnetic nanoparticles or microparticles comprising: an iron oxide (optionally iron oxide magnetite); terfenol-D, or an alloy of the formula TbₓDy₁₋ₓFe₂, wherein x is about 0.3, e.g., at or about 0.27-0.30; terbium, dysprosium and iron alloy; nickel or a nickel-iron alloy (a nonlimiting example being INVAR™); galfenol (an alloy of iron and gallium); or, any material with magnetic properties (i.e., change in magnetization in the presence of magnetic field or vice versa).

The multifunctionality of agile printable inks as provided herein can be demonstrated, such as in experiments described herein, using nickel and iron oxide magnetites as example magnetic nanoparticles (e.g., size range less than about 100 nm, though they can be larger) or microparticles (e.g., size less than about 2 μm, though they can be larger). Initially, an exemplary PVDF/DMSO solution can be prepared by adjusting the volume ratio (more generally, piezoelectric polymeric material to nonpolar organic solvent ratio) to prevent premature gelation or prohibitively high viscosity upon addition of the magnetic filler. The latter is then added at different weight ratios depending on the desired electric, magnetic, and mechanical properties while maintaining printability. Furthermore, the material constituents (electrical, chemical, and magnetic phases) can be readily adjusted to explore new functionalities, scalable synthesis, cost-effective and additive manufacturing for fabricating 3D complicated parts, improve efficiency, sensitivity, and versatility in different operating conditions, and applicable to a broader range of technologies. As nonlimiting examples, electroactive polymer may be increased or otherwise adjusted to, e.g., 15 wt. % with respect to DMSO weight, magnetic MNPs may be increased or otherwise adjusted to, e.g., <20 vol. % with respect to the overall weight of DMSO+PVDF, etc. Other adjustments are possible, and the example adjustments provided herein are not exhaustive. The magnetoelectric composite ink can then be printed into different geometries using any inkjet printer.

Example multifunctional printable ink herein uniquely provides tunable properties along with the use of biocompatible solvents without any mechanical scaffolding materials. By contrast, the latter facilitates printability but significantly reduces functionality.

### EXAMPLES

Inventive features will be further described with reference to examples described herein; however, it is to be understood that the invention is not limited to such examples.

To illustrate certain inventive features and benefits, an example method for making exemplary printable inks and organic-based magneto-strictive magnetoelectric materials as provided herein will now be described.

Organic solvent-based multifunctional base and printable multifunctional magnetoelectric composite inks were synthesized using solution mixing techniques. To synthesize the base ink, at first, an organic solvent-based base material framework was synthesized by mixing 2 g of polyvinylidene fluoride (PVDF) powder (SOLEF 6020™, POLYK Technologies™) with particle size 100 μm and high melting temperature (approximately 170° C.) into 15 mL of ultra-high purity (99.995%) dimethyl sulfoxide (DMSO) in a glass vial or suitable mixing container that was not reactive to the chemicals used herein. The PVDF solute weight ratio to DMSO solvent volume ratio in the experiments was fixed at 1:7.5. The mixture was heated at 75° C. in a water bath for 30 min until a homogeneous, viscous, and transparent mixture was obtained, while the mixture was agitated with a magnetic stirrer at 750 rpm for the first 5 min followed by 250 rpm for 25 min. The PVDV/DMSO resin was kept at room temperature for 20 min before printing using direct ink writing (DIW). Other example synthesizing conditions for the framework may include, but are not limited to, PVDF: DMSO ratio >1:6.5, 1:7, 1:7.5, 1:8, etc.; heating the mixture at a temperature between 70-80° C. and for 30-45 min; stirrer rpm between 225-350; etc.

The magnetoelectric inks were synthesized by adding two different magnetic nanoparticles, i.e., Ni and Fe₃O₄, with different weight ratios (wt. %), including 0.5 wt. %, 1 wt. %, 2 wt. %, and 3 wt. % of the total weight of the PVDF-DMSO solution mixture by adjusting the solute to solvent mixing ratio of 1:10. All magnetic nanoparticles weight measurements were taken inside an inert glove box under Argon, to avoid oxidation of nanoparticles. The previous mixing process was followed for preparing all magnetoelectric inks.

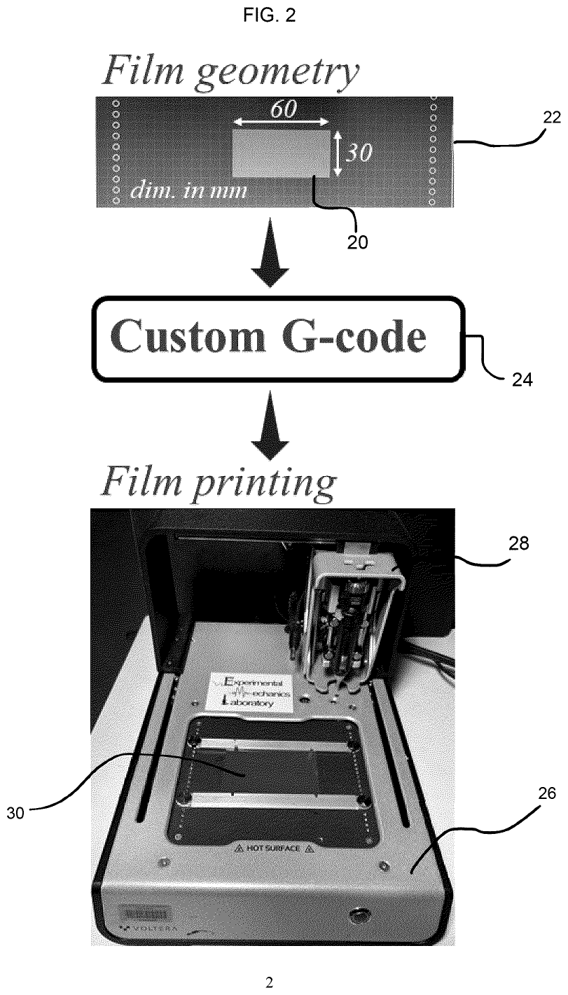

FIG. 2 illustrates an example direct ink writing (DIW) printing process for printing rectangular films in the experiments. Rectangular film samples 20 were designed and modeled with commercial solid modeling software. The target dimensions of the example films were 40 μm thick×60 mm long×30 mm wide, as illustrated in the example grid 22 in FIG. 2. It will be appreciated, however, that the dimensions of the printed objects can be adjusted or changed accordingly. For instance, other geometries for films can be readily prepared, e.g., using standard modeling and slicing software utilities.

Custom G-codes 24 were prepared and used to print several versions of the films using base and magnetoelectric inks using a DIW printing process. The printing parameters were optimized a priori, including layer height of approximately 1 mm, extrusion width 2 mm, and volume flow rate 15 mm³·s⁻¹.

A modified direct ink writing 3D printer, here a V-ONE™ printer (VOLTERA™, Waterloo, Ontario, Canada), or equivalent) 26 was used to print the films. The PVDF/DMSO base or magnetoelectric inks was transferred (loaded) in a 5 mL cartridge 28 fitted with a piston dispensing mechanism to print the films (e.g., deposit a series of strategically located lines) with optimized parameters, including a 230 μm nozzle at pressure of 0.72 Pa and printing speed of 80 mm min 1, onto an approximately 50 mm×75 mm substrate (PCB boards, FR1™ (VOLTERA™) or equivalent) disposed on a surface 30 at ambient conditions. Other substrates may be used, including but not limited to glass slides, plastic plates, or composite panels.

The DIW printed films were cured in a vacuum oven at 120° C. for 2 h. The cured composite films were gently peeled off the substrate print boards using a tweezer to separate the films from the substrate. The thickness of the released films was subsequently measured using an ultrasonic electronic gauge (POSITECTOR 6000™, DEFELSKO™) as a function of composition to ascertain the accuracy of the preparation process.

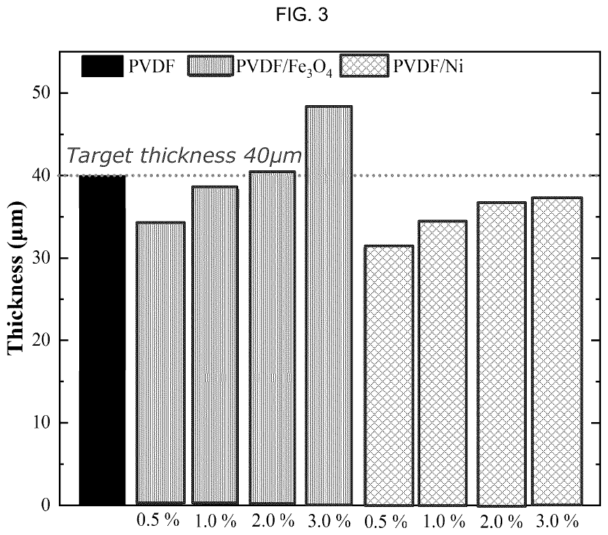

FIG. 3 illustrates example variation of the thickness of the example 3D-printed films as a function of nanoparticle content (wt. %) and type (including nickel magnetic nanoparticles and magnetite nanoparticles, though other nanoparticles may be used). Methods of the present invention for preparing magnetoelectric inks can be agnostic to the type of nanoparticles. The thickness of the printed composite films depends on the solvent-to-solute ratio and the weight % of incorporated nanoparticles in the synthesized ink. As illustrated in FIG. 3, the increase of weight % of nanoparticles into the synthesized ink at a constant ratio of PVDF/DMSO solution increases the thickness of the fabricated films. The thickness can readily be predicted, e.g., with solvent evaporation models by accounting for the deposited volume and solvent weight or volume ratio such that

$$t = \{ \frac{{V}_{P} + {V}_{M N P s}}{{V}_{S} + {V}_{P} + {V}_{M N P s}} \} \times \frac{{V}_{l f}}{{A}_{f}} ,$$

where V_{P}, V_{S}, and V_{MNPs} are the volume of PVDF powder, DMSO solvent, and magnetic nanoparticles, respectively, and V_{lf} and A_{f} are the volume and area of printed film per unit length, respectively.

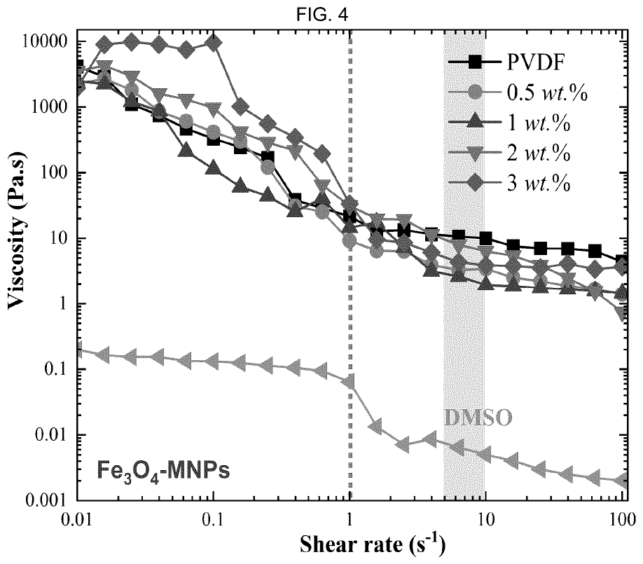

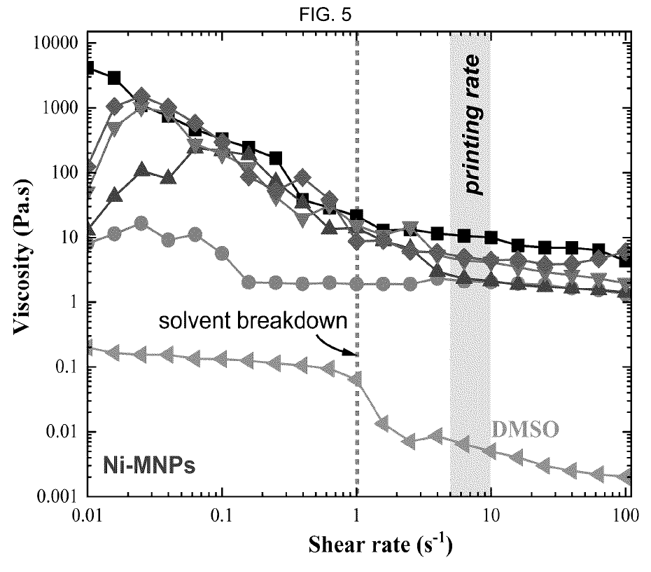

FIG. 4 and FIG. 5 depict rheological properties of example multifunctional printable inks as a function of shear rate (0.01-100 s⁻¹) at room temperature (the printing temperature of the ink and environment) and ink composition regarding the type and weight ratio of the magnetic nanoparticles. FIG. 4 and FIG. 5 also highlight example printing rates that may be useful or optimal for fabricating exemplary artifacts, as incorporating magnetic nanoparticles into the PVDF/DMSO solution increases viscosity and reduces flowability, which can cause clogging at the nozzle tip during printing. FIG. 4 shows rheological properties of magnetite nanoparticle-based magnetoelectric inks at 0.5 wt. %, 1 wt. %, 2 wt. %, and 3 wt. %, while FIG. 5 shows properties of nickel nanoparticle-based inks at the same weight ratios.

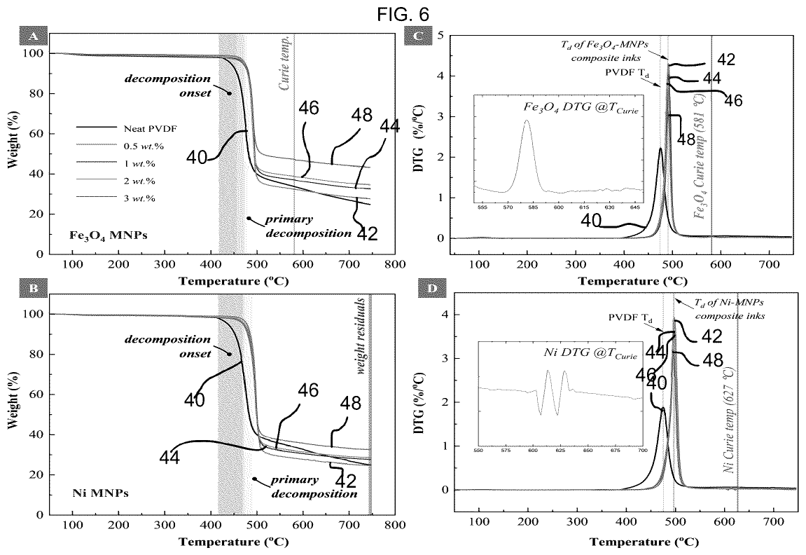

FIGS. 6A-6D depict thermogravimetric (TGA) responses (thermograms) and differential thermograms (DTG) of example synthesized magnetoelectric inks as a function of temperature (room temperature to 750° C.) and magnetic nanoparticle types and weight ratios, including neat PVDF (0 wt. %) 40, 0.5 wt. % 42, 1 wt. % 44, 2 wt. % 46, and 3 wt. % 48. FIGS. 6A-6B depict results for magnetite nanoparticles and FIGS. 6C-6D depict results for nickel nanoparticles. The TGA thermograms were collected in triplicate under nitrogen at a temperature rate of 10° C./min. Thermograms in FIGS. 6A-6D denote the dependence of the thermal decomposition behavior of the synthesized magnetoelectric ink on the type and weight ratio of the magnetic nanoparticles. The decomposition temperatures of neat PVDF, magnetite-based, and nickel-based inks were 476±1.2° C., 489.6±2.3° C., and 497.1±1.4° C., respectively, which are associated with the thermal properties of these materials (e.g., thermal conductivity, specific heat capacity, etc.). FIGS. 6A and 6D also show the Curie temperatures of magnetite and nickel nanoparticles, respectively, confirming the retention of magnetic properties despite the preparation steps.

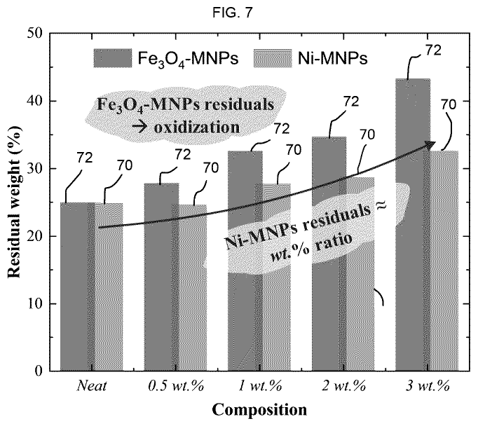

FIG. 7 graphically illustrates the residual weight percentages of the example synthesized and printed inks as a function of composition, including the type and weight ratio of magnetic nanoparticles. The increase in residuals for the nickel-based magnetoelectric resins (bars 70) corresponds to the weight of the nickel magnetic nanoparticles. However, the residual weight ratios for the magnetite nanoparticles (bars 72) indicate that the weight ratios of the initial nanoparticles and oxidation effects play a role in the remaining residuals after pyrolysis at 750° C.

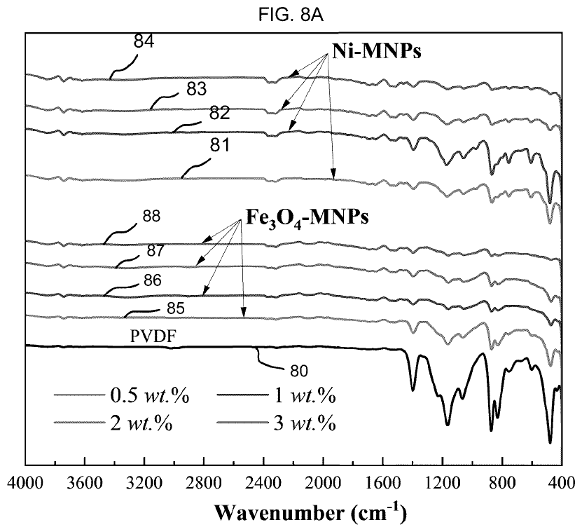

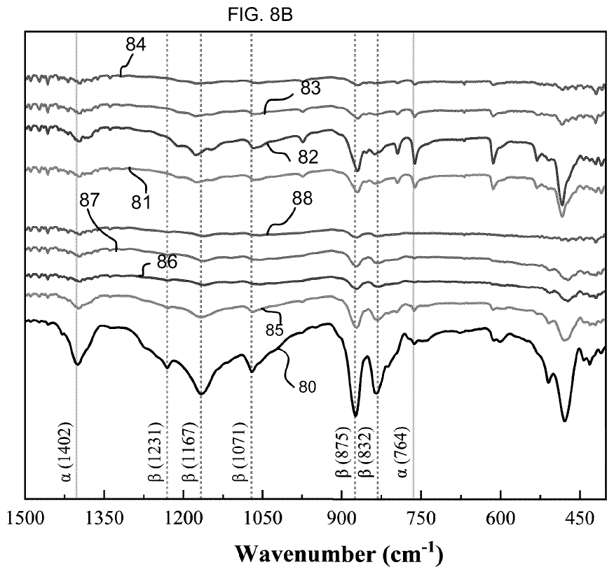

FIGS. 8A-8D show additional analysis results for inks including neat PVDF (0 wt. %) 80, nickel nanoparticles at 0.5 wt. % 81, 1 wt. % 82, 2 wt. % 83, and 3 wt. % 84, and magnetite-based nanoparticles at 0.5 wt. % 85, 1 wt. % 86, 2 wt. % 87, and 3 wt. % 88. FIG. 8A graphically illustrates a physicochemical analysis of multifunctional printable inks using Fourier transform infrared spectroscopy (FTIR) as a function of magnetic nanoparticle type and weight ratio composition from 400 cm⁻¹ to 4000 cm⁻¹. FIG. 8B shows the corresponding FTIR spectra in the fingerprint region, delineating the spectral peaks associated with α and β phases. The IR spectra in FIGS. 8A-8B indicate the coexistence of α and β crystalline phases within 400<λ<1500 cm⁻¹, associated with CF₂—CH₂ monomers in a TG⁺TG⁻ nonpolar and TTTT polar configuration. The α-phase has spectral peaks at 764 cm⁻¹ and 1402 cm⁻¹, while the β-phase ensued at 832 cm⁻¹, 875 cm⁻¹, 1071 cm⁻¹, 1167 cm⁻¹, and 1298 cm⁻¹. The magnetite nanoparticles resulted in vibrational peaks at 530 cm⁻¹ and 566 cm⁻¹ due to Fe—O stretching, at 610-615 cm⁻¹ ascribed to the oxidized maghemite (γFe₂O₃), and at 796 cm⁻¹ ascribed to α-FeOOH. However, the nanoparticles subdued the PVDF peak intensities, indicating that the crystalline structure of the PVDF composites is deformed as a function of the nanoparticles' weight ratio.

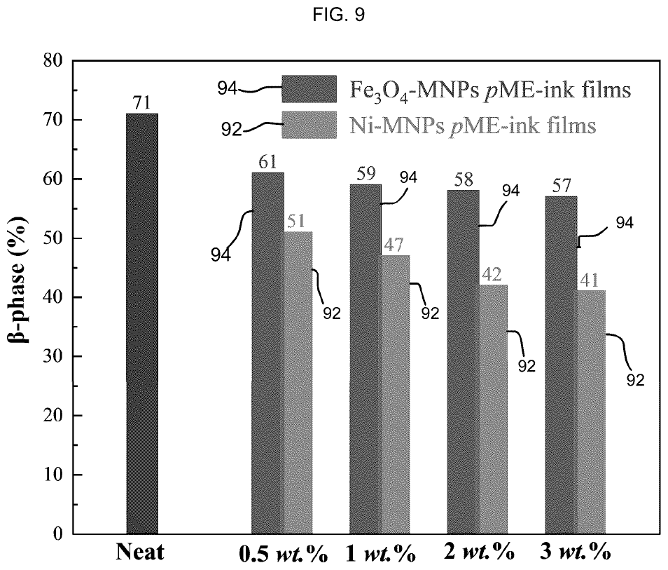

FIG. 9 graphically summarizes B-phase content ratios in the neat PVDF, nickel 92, and magnetite 94 nanoparticles, calculated based on the peaks corresponding to the α- and β-phases at 760 cm⁻¹ (α-phase) and 840 cm⁻¹ (β-phase). The higher β-phase content indicates a more crystalline nature and multifunctional response.

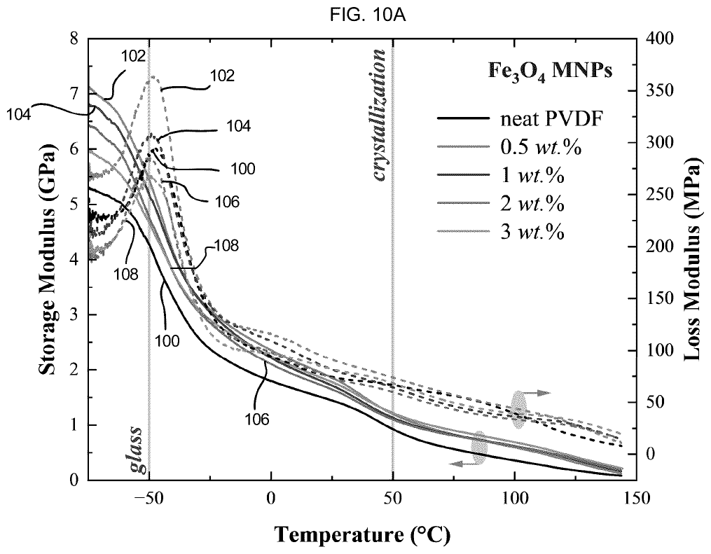

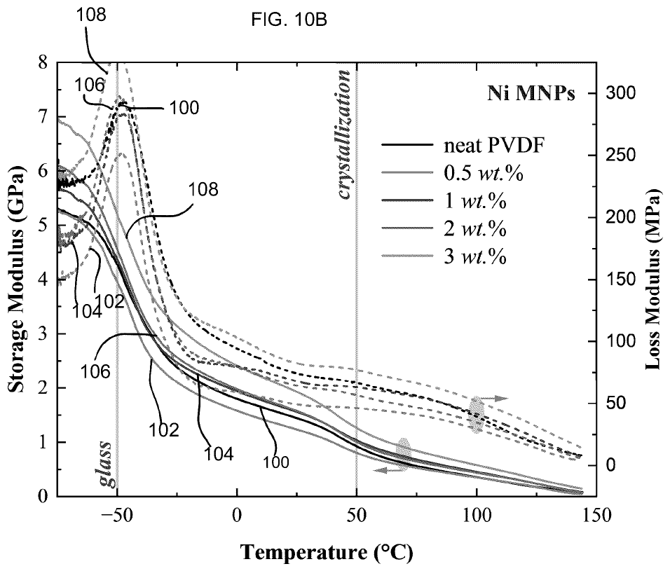

FIGS. 10A-10B graphically illustrate a thermomechanical analysis of example multifunctional printable inks, where strain is oscillating under 20 μm amplitude from −75° C. to 150° C. at 3° C./min. Results are depicted for inks including neat PVDF (0 wt. %) 100, nickel nanoparticles at 0.5 wt. % 102, 1 wt. % 104, 2 wt. % 106, and 3 wt. % 108 (FIG. 10B), and magnetite-based nanoparticles at 0.5 wt. % 110, 1 wt. % 112, 2 wt. % 114, and 3 wt. % 116 (FIG. 10A).

The viscoelastic response of 3D printed films is summarized in FIGS. 10A-10B, showing the storage (E′) and loss (E″) moduli as a function of temperature, extending from −75° C. to 150° C. The evolution in the time-dependent response, irrespective of the magnetic nanoparticle type and weight ratio, exemplifies (1) slight decreasing glass transition (T_{g}) due to conformational changes associated with the final film composition and digression in degree of crystallinity, (2) enhancement in the material stiffness stemming from the nanomechanical hybridization with the magnetic nanoparticles that improves the effective load-bearing capacity, and (3) broadening of the operating range by extending the rubbery regime based on the localized relaxation afforded by the magnetic nanoparticles. Generally, lower T_{g} as a function of magnetic nanoparticles weight ratios can be attributed to the increase in amorphous phase and weak interaction between the reinforcing nanoparticles and the PVDF polymer chains with lower crystallinity. In addition to T_{g}, the thermomechanical spectra in FIGS. 10A-10B also highlight the manifestation of a secondary transition within the rubbery regime, i.e., Tᵣ≈95° C., which is associated with enhanced dampening properties of the example 3D printed composite films. As the temperature increases, the magnetic nanoparticles result in free volume emancipation and mobility; hence, the sliding position of Tr along the temperature axis as the composition changes with respect to the a to B phases. The viscoelastic response of 3D printed inks implies an extended temperature range, suitable for wearable and flexible electronics and flexible microscale robotics in various harsh operating conditions.

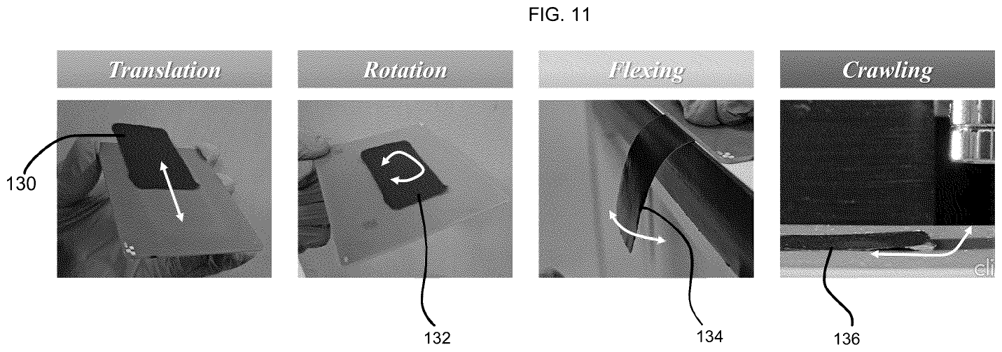

FIG. 11 depicts views of example 3D printed magnetoelectric films performing various motions, respectively, including: (a) translation 130; (b) rotation 132; (c) flexing 134; and (d) crawling 136 under the influence of permanent magnets. The responsiveness of the example 3D printed films to external magnetic field demonstrates the functionality of these additively manufactured artifacts.

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in a different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure.

Other embodiments may be utilized, and other changes may be made, without departing from the scope of the subject matter presented herein. It will be readily understood that the aspects of the present disclosure, as generally described herein and illustrated in the figures, can be arranged, substituted, combined, separated, and designed in a wide variety of different configurations, all of which are explicitly contemplated herein.

Any of the above aspects and embodiments can be combined with any other aspect or embodiment as disclosed here in the Summary, Figures and/or Detailed Description sections.

As used in this specification and the claims, the singular forms “a,” “an” and “the” include plural referents unless the context clearly dictates otherwise.

Unless specifically stated or obvious from context, as used herein, the term “or” is understood to be inclusive and covers both “or” and “and”.

Unless specifically stated or obvious from context, as used herein, the term “about” is understood as within a range of normal tolerance in the art, for example within 2 standard deviations of the mean. About can be understood as within 20%, 19%, 18%, 17%, 16%, 15%, 14%, 13%, 12%, 11%, 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless specifically stated or obvious from context, as used herein, the terms “substantially all”, “substantially most of”, “substantially all of” or “majority of” encompass at least about 90%, 95%, 97%, 98%, 99% or 99.5%, or more of a referenced amount of a composition.

The entirety of each patent, patent application, publication, and document referenced herein is hereby incorporated by reference. Citation of the above patents, patent applications, publications, and documents is not an admission that any of the foregoing is pertinent prior art, nor does it constitute any admission as to the contents or date of these publications or documents. Incorporation by reference of these documents, standing alone, should not be construed as an assertion or admission that any portion of the contents of any document is considered to be essential material for satisfying any national or regional statutory disclosure requirement for patent applications. Notwithstanding, the right is reserved for relying upon any of such documents, where appropriate, for providing material deemed essential to the claimed subject matter by an examining authority or court.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein may suitably be practiced in the absence of any element(s) not specifically disclosed herein. Thus, for example, in each instance herein, any of the terms “comprising”, “consisting essentially of”, and “consisting of” may be replaced with either of the other two terms. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

A number of embodiments of the invention have been described. Nevertheless, it can be understood that various modifications may be made without departing from the spirit and scope of the invention. Accordingly, other embodiments are within the scope of the following claims.

What is claimed is:

1. A printable ink, or an organic-based magneto-strictive magnetoelectric material, comprising: poly(vinylidene fluoride) and/or polyvinylidene fluoride (also called polyvinylidene difluoride, or PVDF) dissolved in a nonpolar organic solvent, where a piezoelectric polymer is dissolvable (optionally dimethyl sulfoxide (DMSO), or equivalent).

2. The printable ink or the organic-based magneto-strictive magnetoelectric material of claim 1, wherein the printable ink or organic-based magneto-strictive magnetoelectric material is contained on and/or within a plurality of nickel (Ni) and/or ferric oxide (Fe₃O₄) nanoparticles and/or microparticles.

3. The printable ink or the organic-based magneto-strictive magnetoelectric material of claim 2, wherein the printable ink or the organic based magneto-strictive magnetoelectric material has between about 0.25 weight (wt.) % to 10 wt. %, or 0.5 wt. %, 1 wt. %, 2 wt. %, 3 wt. %, 4 wt. %, 5 wt. %, 6 wt. % or 7 wt. %, of plurality of nickel (Ni) and and/or ferric oxide (Fe₃O₄) nanoparticles and/or microparticles.

4. The printable ink or the organic-based magneto-strictive magnetoelectric material of claim 1, wherein the nonpolar organic solvent comprises dimethyl sulfoxide (DMSO) or equivalent.

5. The printable ink or the organic based magneto-strictive magnetoelectric material of claim 4, wherein the dimethyl sulfoxide or equivalent comprises: a zwitterion-type ionic liquid (ZIL) (optionally 1-[2-(2-methoxyethoxy)ethyl]-3-(3-carboxypropyl)-imidazolium (OE2imC3C) and 1-[2-(2-methoxyethoxy)ethyl]-3-(3-carboxypentyl)-imidazolium (OE2imC5C)); dihydrolevoglucosenone (or CYRENE™); or, mixtures of: DMSO/ethyl acetate (EtOAc), DMSO/1,3-dioxolane (DOL) or DMSO/2-methyl tetrahydrofuran (2-Me-THF)).

6. The printable ink or the organic-based magneto-strictive magnetoelectric material of claim 1, further comprising an ultraviolet photo-initiator.

7. The printable ink or the organic-based magneto-strictive magnetoelectric material of claim 6, wherein the photo-initiator is tuned at 405 nm.

8. The printable ink or the organic-based magneto-strictive magnetoelectric material of claim 6, wherein the photo-initiator comprises: VA-086, CAS no. 61551-69-7 (also known as 2,2′-Azobis [2-methyl-N-(2-hydroxyethyl) propionamide]); LUCIRIN™ (BASF), camphorquinone (CQ); Hydroxyacetophenone (HAP), and/or Phosphineoxide (TPO).

9. The printable ink or the organic-based magneto-strictive magnetoelectric material of claim 1, further comprising a plurality of magnetic nanoparticles or microparticles.

10. The printable ink or the organic based magneto-strictive magnetoelectric material of claim 9, wherein the plurality of magnetic nanoparticles or microparticles comprise or are fabricated with: an iron oxide (optionally iron oxide magnetite); terfenol-D, or an alloy of the formula TbₓDy₁₋ₓFe₂, wherein x is about 0.3; terbium, dysprosium and iron alloy; nickel or a nickel-iron alloy (such as INVAR™); galfenol (an alloy of iron and gallium), or, any material capable of changing magnetization in the presence of magnetic field.

11. A product of manufacture comprising or incorporating therein printable ink, or an organic based magneto-strictive magnetoelectric material of claim 1.

12. The product of manufacture of claim 11, wherein the product of manufacture is fabricated as or using a 3D printer.

13. The product of manufacture of claim 12, wherein the 3D printer comprises or is equipped with an in situ flash heating element to assist in evaporating a DMSO or equivalent solvent at a specified temperature below the solvent's flash point.

14. The product of manufacture of claim 11, wherein the product of manufacture is fabricated as a wearable electronic device, an acquiescent energy storage or conversion device, a flexible or wearable item or device, and/or a flexible or wearable item of medical equipment or medical device.

15. A method of making a printable ink or an organic-based magneto-strictive magnetoelectric material, comprising:
(a) mixing poly(vinylidene fluoride), polyvinylidene fluoride (also called polyvinylidene difluoride, or PVDF) in a nonpolar organic solvent, where a piezoelectric polymer is dissolvable,
(b) adding the mix of step (a) into and/or onto a plurality of nickel (Ni) and/or ferric oxide (Fe₃O₄) microparticles or nanoparticles.

16. The method of claim 15, wherein the nonpolar organic solvent comprises dimethyl sulfoxide (DMSO) or an equivalent.

17. The method of claim 16, wherein the dimethyl sulfoxide or equivalent comprises: a zwitterion-type ionic liquid (ZIL) (optionally 1-[2-(2-methoxyethoxy)ethyl]-3-(3-carboxypropyl)-imidazolium (OE2imC3C) and 1-[2-(2-methoxyethoxy)ethyl]-3-(3-carboxypentyl)-imidazolium (OE2imC5C)); dihydrolevoglucosenone (or CYRENE™); or, mixtures of: DMSO/ethyl acetate (EtOAc), DMSO/1,3-dioxolane (DOL) or DMSO/2-methyl tetrahydrofuran (2-Me-THF)).

18. The method of claim 15, wherein said mixing comprises stirring for about 30 minutes (min.) at about 75° C., or spinning for about 5 min at about 750 rpm, then spinning for about 25 min at about 250 rpm.

19. The method of claim 15, further comprising:
fabricating one or more films using the printable ink or an organic-based magneto-strictive magnetoelectric material via a direct ink writing (DIW) printing process.

20. The method of claim 10, wherein said fabricating comprises:
configuring a 3D printer to print a film using one or more printing parameters, wherein the 3D printer prints the film onto a substrate;
curing the film; and
separating the cured film from the substrate.
